(19) United States
(12) Patent Application Publication
(10) Pub. No.: US 2003/0122423 A1
(43) Pub. Date: Jul. 3, 2003

(54) High stiffness track assembly for undercarriage noise reduction

(75) Inventors: Bappaditya Banerjee, Peoria, IL (US); Thor T. Norgaard, Washington, IL (US); Eddie D. Janszen, Washington, IL (US)

Correspondence Address: Finnegan, Henderson, Farabow,, Garrett & Dunner, L.L.P., 1300 I Street, N.W., Washington, DC, 20005-3315, US

(73) Assignee: Caterpillar Inc.

(21) Appl. No.: 10/026,558

(22) Filed: Dec. 27, 2001

(51) Int. Cl. B62D 55/08

(52) U.S. Cl. 305/159

(57) ABSTRACT

A track assembly for a track-type machine includes a link assembly having a plurality of interconnected link sets forming an oval track path, a plurality of track shoes, each being coupled to a respective link set, and an elastic member located between a plurality of successive link sets and a plurality of respective track shoes. The elastic member extends continuously along each individual link set of the plurality of successive link sets. The elastic member may extend along substantially the entire oval track path. The elastic member serves to stiffen the link assembly and thereby reduce the amount and force of impacts between the link assembly and other elements of the undercarriage of the track-type machine, resulting in a reduction in the amount of noise emanating from the machine operation.

### TECHNICAL FIELD

This invention relates to a device for reducing the noises emanating from an undercarriage of a track-type machine during operation.

### BACKGROUND

Conventional track-type machines emit operational noises that are often considered objectionable to individuals in the vicinity of the machine. The disturbance associated with such noise is compounded by the fact that track-type machines are often operated in places of high human population, such as near office buildings or apartment complexes.

A portion of the noise created by track-type machines can be attributed to the metal-to-metal contact of the undercarriage of the machine during operation. For example, noises are caused by metal-to-metal contact between the teeth of the drive sprocket and the bushings interconnecting the links of a link assembly, between the surfaces of the idler roller and the links, and between the rolling surface of the carrier rollers and the links. Many attempts have been proposed to reduce the noises created by the undercarriage of track-type machines. For example, U.S. Pat. No. 4,099,796 to Groff discloses a track assembly including track shoes having a cover plate and viscoelastic material affixed to an inner, link-side surface of the track shoes. The cover plate and viscoelastic material act to reduce the noise of the undercarriage of the track-type machine by dissipating and absorbing vibrations of the track shoe during operation. This attempt at reducing the vibrational noise of the undercarriage of track-type machines, however, suffers the drawbacks that this energy dissipating mechanism is limited in the amount of energy that can be absorbed. Further, the cover plates and viscoelastic material disclosed in Groff are not designed to reduce the force and amount of impacts between the link assembly and other components of the undercarriage. The attaching of individual cover plates and viscoelastic material to each track shoe may also be cost prohibitive.

The present invention provides an apparatus for reducing the noise of an undercarriage of a track-type machine that avoids some or all of the aforesaid shortcomings in the prior art.

### SUMMARY OF THE INVENTION

In accordance with one aspect of the invention, a track assembly for a track-type machine includes a link assembly having a plurality interconnected link sets forming an oval track path, a plurality of track shoes, each being coupled to a respective link set, and at least one elastic member located between a plurality of successive link sets and a plurality of respective track shoes, the at least one elastic member extending continuously along each individual link set of the plurality of successive link sets.

According to another aspect of the present invention, a track assembly includes a link assembly having a plurality of interconnected link sets forming an oval track path, a plurality of track shoes, each being coupled to a respective link set, and an elastic strip located between the link sets and the track shoes and extending over substantially the entire oval track path.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several exemplary embodiments of the invention and together with the description, serve to explain the principles of the invention.

### BRIEF DESCRIPTION OF THE DRAWINGS

FIG. 1 is a perspective view of a track-type machine incorporating an exemplary embodiment of the present invention;

FIG. 2 is a partial perspective view of the track assembly of FIG. 1;

FIG. 3 is an exploded partial view of the track assembly of FIG. 1;

FIG. 4 is a perspective view of the attachment of the stiffening strip to the track assembly in accordance with an exemplary embodiment of the present invention; and

FIG. 5 is a top view of an exemplary embodiment of a shim according to the present invention.

### DETAILED DESCRIPTION

Reference will now be made in detail to the exemplary embodiments of the invention, examples of which are illustrated in the accompanying drawings. Wherever possible, the same reference numbers will be used throughout the drawings to refer to the same or like parts.

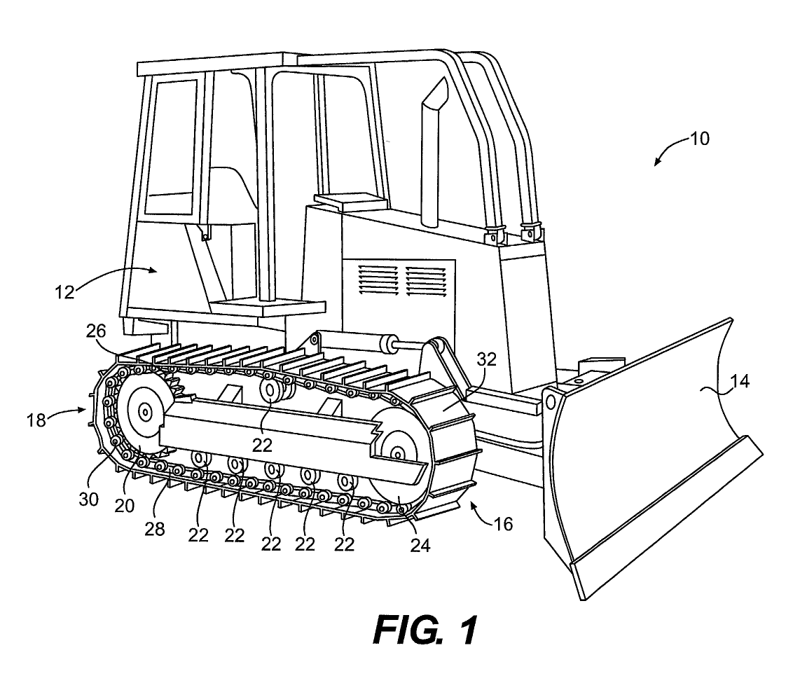

FIG. 1 illustrates a track-type machine 10 incorporating the present invention. Track-type machines as defined herein may include, for example, any machine incorporating a track or crawler-type driving system. Such driving systems are commonly used in earth moving, earth digging, and earth carrying machines. Track-type machine 10 may include a machine body 12, a blade member 14, and an undercarriage 16 having a track assembly 18. Although not shown in FIG. 1, undercarriage 16 of track-type machine 10 may include a second track assembly located on a side of machine body 12 opposite track assembly 18.

FIG. 1 further illustrates the basic components that may be included in an undercarriage 16 of a track-type machine 10 according to the present invention. For example, undercarriage 16 may include a drive sprocket 20, carrier rollers 22 and an idler roller 24 together forming a generally oval track path for a link assembly 28. Drive sprocket 20 may be rotated by an engine (not shown) of track-type machine 10 causing the teeth 26 of drive sprocket 20 to engage bushings 30 of link assembly 28 to rotate link assembly 28 about the oval track path. Track shoes 32 may be coupled to outer portions of link assembly 28 to form a ground contacting traction surface of track assembly 18.

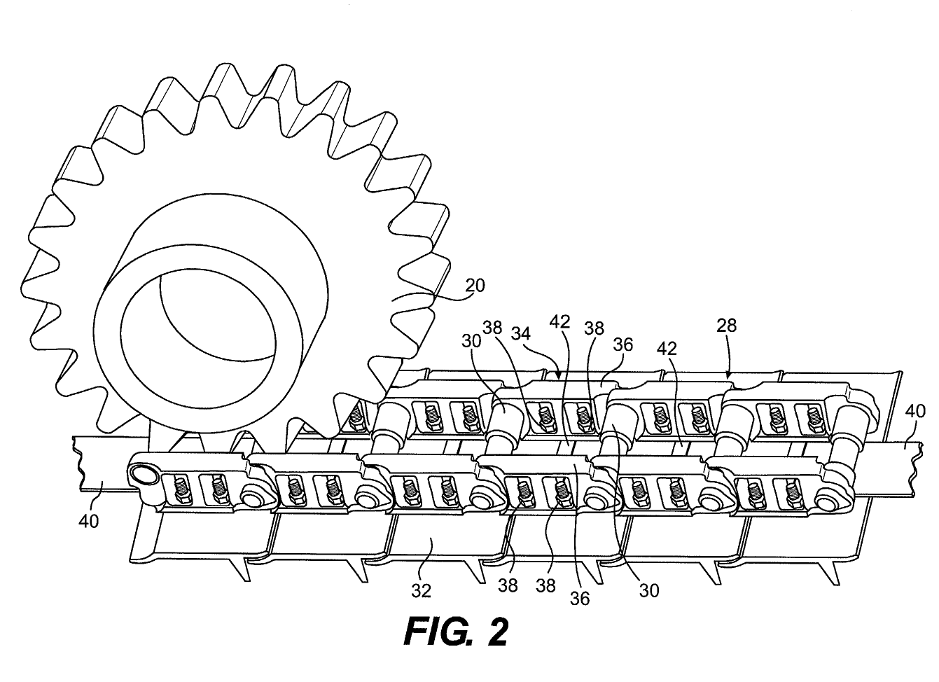

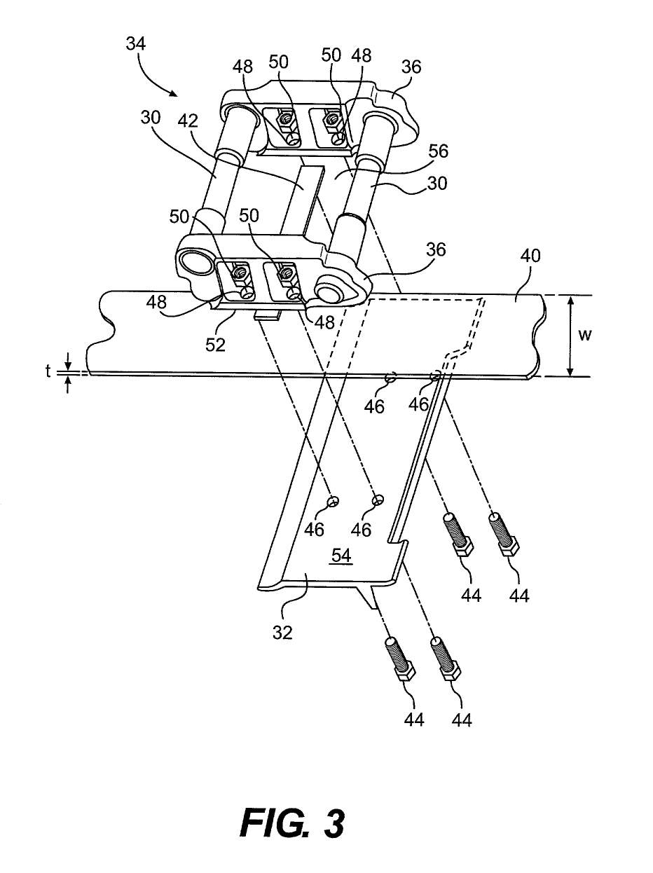

Referring to FIG. 2, link assembly 28 may be formed by a successive set of interconnected link sets 34. Link sets 34 may include two (2) opposing links 36 connected to each other by a pair of bushings 30. Link sets 34 may be coupled to track shoes 32 by a plurality of fasteners 38. As described in more detail below in connection with FIG. 3, a stiffening strip 40 in the form of an elastic strip member may be located between track shoes 32 and link assembly 28 and extend substantially the entire oval track path of link assembly 28. Stiffening strip 40 may be supported at each link set 34 by a shim 42 bridging opposing links 36 of each link set 34.

FIG. 3 illustrates an exploded view of the connection of a single link set 34 and a single track shoe 32 in accordance with an exemplary embodiment of the present invention. Four (4) bolts 44 of fasteners 38 may extend through bolt holes 46 of track shoe 32 and bolt holes 48 of link set 34 and be secured by nuts 50. Prior to coupling track shoe 32 to link set 34, a rectangular-shaped shim 42 may be affixed to an outer surface 52 of link set 34 to bridge links 36. Shim 42 may be affixed to links 36 so as not to obstruct bolt holes 46 and 48. Stiffening strip 40 may be located between the outer surface 52 of link set 34 and an inner surface 54 of track shoe 32 and be urged by shim 42 so as not to extend into the link space 56 formed between links 36 and bushings 30 of link assembly 28.

Stiffening strip 40 may be formed of an elastic strip member of any type of material capable of absorbing impact loads and vibrations. The term “elastic” as used herein includes any material capable of sustaining deformation without permanent loss of size or shape. For example, stiffening strip 40 may be formed of a two (2) ply styrene-butadiene rubber (SBR) or a three (3) ply polyurethane. For certain exemplary applications, stiffening strip 40 may have a width (w) in the range of approximately 6.35 cm (2.5 inches) to 8.89 cm (3.5 inches), and a thickness (t) in the range of approximately 0.635 cm (0.25 inches) to 0.762 cm (0.3 inches). Stiffening strip 40, however, may be formed of any width or thickness dimensions allowing for proper coupling of track shoe 32 to link set 34.

Stiffening strip 40 may be formed as a continuous strip having a length sufficient to extend over each link set 34 of link assembly 28. The appropriate length of stiffening strip 40 may be calculated by applying a uniaxial tension test to stiffening strip 40 to determine its yield strength and its strain energy at yield. The length of stiffening strip 40 and the tension to be applied to stiffening strip 40 during attachment to track assembly 18 may then be selected so that stiffening strip 40 can withstand the kinetic energy of the track assembly 28. The present invention also contemplates stiffening strip 40 being formed of a plurality of elastic members coupled between all or only a portion of link sets 34.

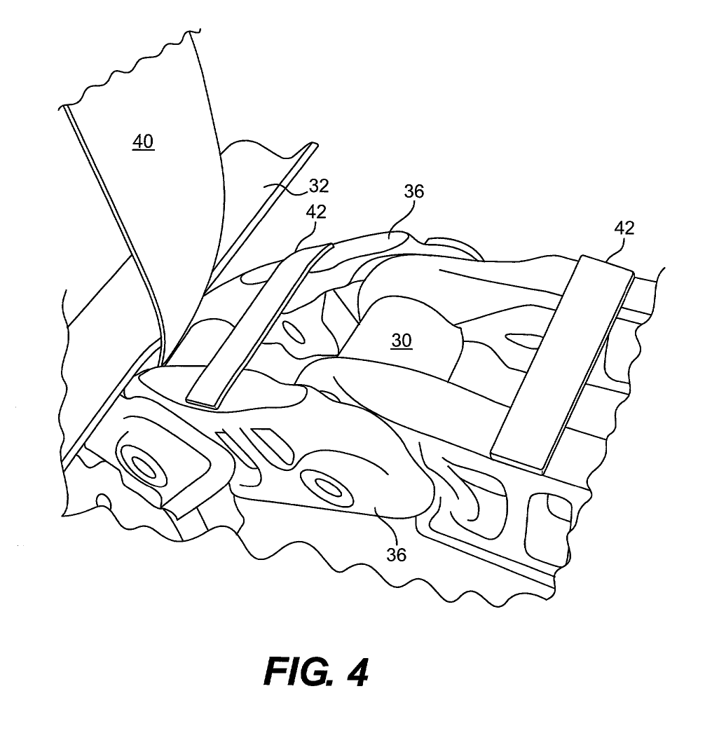

FIG. 4 illustrates a method by which stiffening strip 40 may be coupled to track assembly 18. Shim 42 may be attached between links 36 of each link set 34 in any appropriate manner, for example by adhesion. One end of stiffening strip 40 may then be placed over a single link set 34, and a track shoe 32 bolted in place with fasteners 38. The fastening of track shoe 32 to link set 34 acts to clamp stiffening strip 40 in place between link set 34 and track shoe 32. After one end of stiffening strip 40 is clamped in position, stiffening strip 40 may be appropriately tensioned and another track shoe 32 may be fastened to a successive link set 34 to clamp the next successive portion of stiffening strip 40 in position. This process is repeated until the entire stiffening strip 40 is mounted to the link assembly 28.

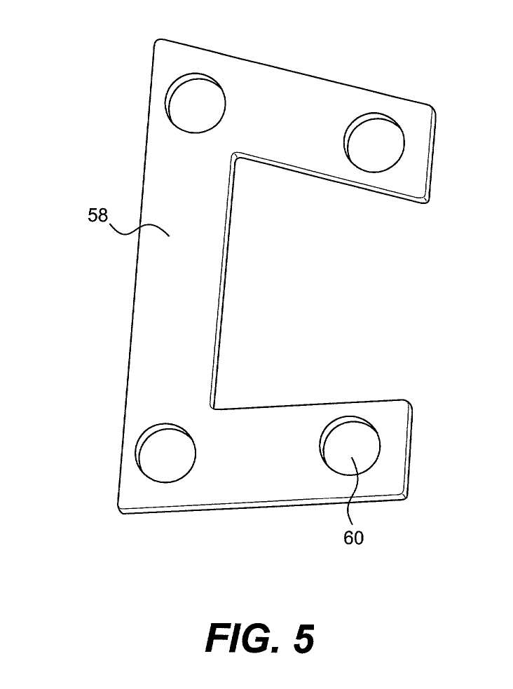

FIG. 5 illustrates an alternative shim 58 according to the present invention. Shim 58 may be formed in a generally C-shaped configuration with holes 60 extending therethrough to align with bolt holes 46 of track shoe 32 and bolt holes 48 of link set 34. Shim 42 and shim 58 may be formed of any rigid material and have a thickness sufficient to prohibit stiffening strip 40 from entering link space 56. For example, shims 42 or 58 may be formed of steel or aluminum and have a thickness up to approximately 0.636 cm (0.24 inches). Shims 42 and 58 may also include rounded edges and corners to reduce scratching or scoring of stiffening strip 40 resulting from contact with shims 42 or 58.

### INDUSTRIAL APPLICABILITY

During operation of track assembly 18 of track-type machine 10, stiffening strip 40 acts to increase the stiffness of link assembly 28 and thus reduce its play. A reduction in the play of link assembly 28 reduces the number and force of impacts between link assembly 28 and other components of undercarriage 16 during operation. Reducing the force and number of impacts between elements at undercarriage 16 reduces the noise produced by track-type machine 10. Further, stiffening strip 40 also provides an impact impedance reduction at the interface of the track shoes and link assembly. This impedance reduction also acts to reduce the noise radiated from undercarriage 16.

As noted above, stiffening strip 40 may be formed of a continuous elastic strip coupled about substantially the entire oval track path of link assembly 28, or may be formed of a plurality of elastic members together extending over all or a portion of the oval track path. A track assembly 18 having at least one elastic member coupled to at least two (2) successive link sets 34 and corresponding track shoes 32 will still provide benefits associated with an increased stiffness of link assembly 28.

It is contemplated that this cost-effective noise reduction system may have wide application in all types of track-type machines. This system may be installed on new machines during the manufacturing process or may be retrofitted onto existing machines in the field.

Other embodiments of the invention will be apparent to those skilled in the art from consideration of the specification and practice of the invention disclosed herein. For example, many different alternatives for coupling link sets 34 to track shoes 32 are possible in accordance with the present invention. Further, washers may be included about holes 46 or 48 when using shim 42. The washers may protect stiffening strip 40 from detrimental wear resulting from contact with rough surfaces adjacent holes 46 and 48. It is intended that the specification and examples be considered as exemplary only, with a true scope and spirit of the invention being indicated by the following claims.

What is claimed is:

1. A track assembly for a track-type machine, comprising:
a link assembly including a plurality of interconnected link sets forming an oval track path;
a plurality of track shoes, each being coupled to a respective link set; and
at least one elastic member located between a plurality of successive link sets and a plurality of respective track shoes, the at least one elastic member extending continuously along each individual link set of the plurality of successive link sets.

2. A track assembly according to claim 1, wherein each link set includes a pair of opposing links, and a shim bridges the opposing links of each link set of the successive link sets and is located between the link sets of the successive link sets and the at least one elastic member.

3. A track assembly according to claim 2, wherein the shim is rectangular in shape.

4. A track assembly according to claim 2, wherein the shim is formed in a generally C-shaped configuration.

5. A track assembly according to claim 1, wherein the at least one elastic member is formed of one of a styrene-butadiene rubber and polyurethane.

6. A track assembly according to claim 1, wherein each link set of the plurality of successive link sets includes a pair of opposing links, each of the opposing links having at least one hole extending therethrough, and the at least one elastic member is located within a space defined between the at least one hole of the opposing links.

7. A track-type machine including the track assembly of claim 1.

8. A track assembly for a track-type machine, comprising:
a link assembly including a plurality of interconnected link sets forming an oval track path;
a plurality of track shoes, each being coupled to a respective link set; and
a stiffening strip located between the link sets and the track shoes and extending over substantially the entire oval track path.

9. A track assembly according to claim 8, wherein each link set includes a pair of opposing links, and a shim bridges the opposing links of each link set of the track assembly, the shim being located between the link sets and the stiffening strip and being formed in one of a rectangular and generally C-shaped configuration.

10. A track assembly according to claim 8, wherein the stiffening strip is formed of one of a styrene-butadiene rubber and polyurethane.

11. A track assembly according to claim 8, wherein each link set includes a pair of opposing links, each of the opposing links having at least one hole extending therethrough, and the stiffening strip is located within a space defined between the at least one hole of the opposing links.

12. A track-type machine including the track assembly of claim 8.

13. A track assembly for a track-type machine, comprising:
a link assembly including a plurality of interconnected link sets forming an oval track path, each link set including a pair of opposing links;
a plurality of track shoes, each being coupled to a respective link set;
a stiffening strip located between the link sets and the track shoes and extending over substantially the entire oval track path; and
a shim bridging the opposing links of each link set of the link assembly, the shim being located between the link set and the stiffening strip.
